(19) United States
(12) Patent Application Publication
(10) Pub. No.: US 2008/0144704 A1
(43) Pub. Date: Jun. 19, 2008

(54) Spreading codes

(75) Inventor: Qin Zhengdi, Tampere (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/642,811

(22) Filed: Dec. 19, 2006

(51) Int. Cl. H04B 1/707

(52) U.S. Cl. 375/149

(57) ABSTRACT

An apparatus including a spreading code generator for generating a spreading code; a scrambling code generator for generating a scrambling code; and a modulator for scrambling the spreading code using the scrambling code to produce a modified spreading code.

### FIELD OF THE INVENTION

Embodiments of the present invention relate to spreading codes.

### BACKGROUND TO THE INVENTION

Spreading codes have a number of applications. For example, they may be used to encode data so that it can be sent via a communications channel and be accurately recovered at a receiver. The use of the spreading code increases the robustness of the communication channel to interference. Such a spread spectrum technique is for example used in code division multiple access radio communications systems and also in low power communication systems such as global navigation satellite systems (GNSS).

Another application is security. A spreading code may be used to encode information or data. The spreading obscures the data and knowledge of the spreading code is required to recover the original data.

Traditionally spreading codes have been generated using hardware such as linear feedback shift registers (LFSR). A problem with a LFSR that it can only generate codes of length 2^{m}−1, where m is a positive integer.

Complex software solutions are also currently available for code generation that do have this code length limitation. However, such complex software solutions are processor and memory intensive.

It would be desirable to provide an alternative solution for spreading code generation.

### BRIEF DESCRIPTION OF THE INVENTION

According to one embodiment of the invention there is provided an apparatus comprising: a spreading code generator for generating a spreading code having a first chip rate M1; a scrambling code generator for generating a scrambling code having a second chip rate M2 that is greater than the first chip rate; and a modulator for scrambling the spreading code using the scrambling code to produce a modified spreading code having a third chip rate that is greater then the first chip rate M1.

According to another embodiment of the invention there is provided a method comprising: generating a spreading code using hardware; and scrambling the spreading code using a scrambling code.

According to a further embodiment of the invention there is provided a method comprising: generating spreading codes using hardware;

in a first mode, de-spreading data received from a first satellite positioning system using a generated spreading code; in a second mode, scrambling a generated spreading code using a scrambling code and de-spreading data received from a second satellite positioning system using the scrambled spreading code.

According to another embodiment of the invention there is provided a computer program comprising computer program instructions for generating a scrambling code for scrambling a generated spreading code to generate a scrambled spreading code.

According to another embodiment of the invention there is provided an apparatus comprising: a spreading code generator for generating a spreading code having M1 chips in a first time period; a scrambling code generator for generating a scrambling code having M2 chips in the first time period; and a modulator for scrambling the spreading code using the scrambling code to produce a modified spreading code, the M1 chips of the spreading code being spread by the M2 chips of the scrambling code to produce M2 chips in the first time period.

According to another embodiment of the invention there is provided an apparatus comprising: a spreading code generator for generating a spreading code; a scrambling code generator for generating a scrambling code; and a modulator for spreading the spreading code using the scrambling code to produce a modified spreading code.

### BRIEF DESCRIPTION OF THE DRAWINGS

For a better understanding of the present invention reference will now be made by way of example only to the accompanying drawings in which:

FIG. 1 schematically illustrates an apparatus for generating a spreading code;

FIG. 2 schematically illustrates a hardware generated spreading code S1, a software generated scrambling code S2 and a scrambled spreading code S3;

FIG. 3 schematically illustrates a spreading code generator implemented as a linear feedback shift register;

FIG. 4 schematically illustrates a computer for implementing a scrambling code generator and/or a controller;

FIG. 5A, schematically illustrates an encoder comprising the spreading code generator apparatus;

FIG. 5B schematically illustrates a decoder comprising the spreading code generator apparatus; and

FIG. 6 schematically illustrates a method suitable for use in a dual mode GNSS apparatus that is operable in a first GNSS mode and a second GNSS mode.

### DETAILED DESCRIPTION OF EMBODIMENTS OF THE INVENTION

FIG. 1 schematically illustrates an apparatus 10 for generating a spreading code. The apparatus 10 comprises a spreading code generator 2 for generating a spreading code S1, a scrambling code generator 6 for generating a scrambling code S2 and a modulator 12 for modulating the spreading code S1 using the scrambling code S2 to generate the output spreading code S3.

The apparatus 10 may also optionally comprise a controller 8 for controlling operation of the scrambling code generator 6.

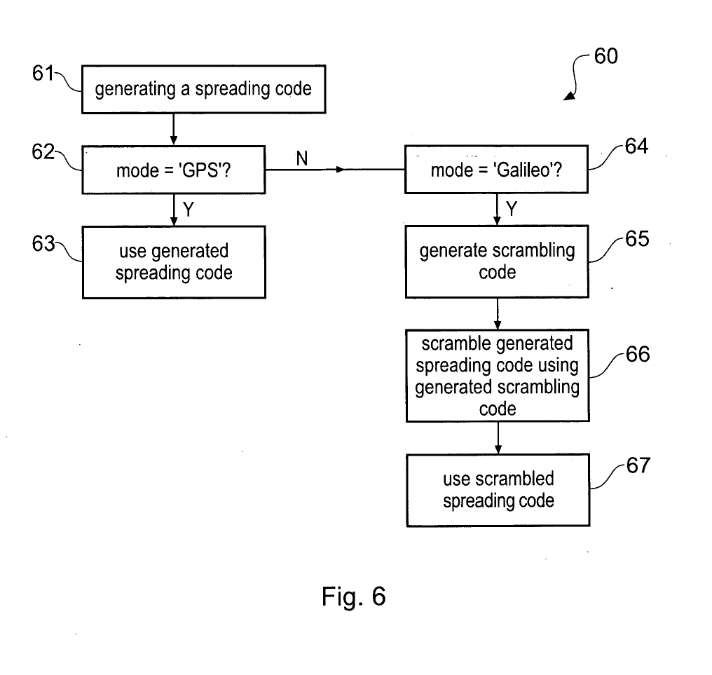

The scrambling code generator apparatus 10 may have one or more modes of operation as described in more detail in relation to FIG. 6. The transition between the modes is controlled by the controller 8. In a first “GPS” mode of operation, the controller 8 may switch off the scrambling code generator 6 so that the output spreading code S3 is the same as the generated spreading code S1. In a “Galileo” mode of operation, the controller 8 controls the scrambling code generator 6 to produce an appropriate scrambling code S2 for scrambling the generated spreading code S1.

The scrambling code generator 6 and the controller 8 may be implemented using a computer 4 as illustrated in FIG. 4. The computer 4 comprises a processor 14 and a memory 16. The processor 14 is arranged to read from and write to the memory 16. The memory 16 comprises computer program instructions 18, which when loaded into the processor 14 control the operation of the computer 4. The computer 4 also has an output port 19 connected to the processor 14 for providing the scrambling code S2.

The computer program 18 comprises computer program instructions which when loaded into the processor 14 enable it to operate as a software enabled scrambling code generator 6 and also as a software enabled controller 8.

The computer program instructions 18 provide the logic and routines that enables the process illustrated in FIG. 6.

The computer program instructions 18 may arrive at the computer 4 via an electromagnetic carrier signal or be copied from a physical entity 15 such as a computer program product, a memory device or a record medium such as a CD-ROM or DVD.

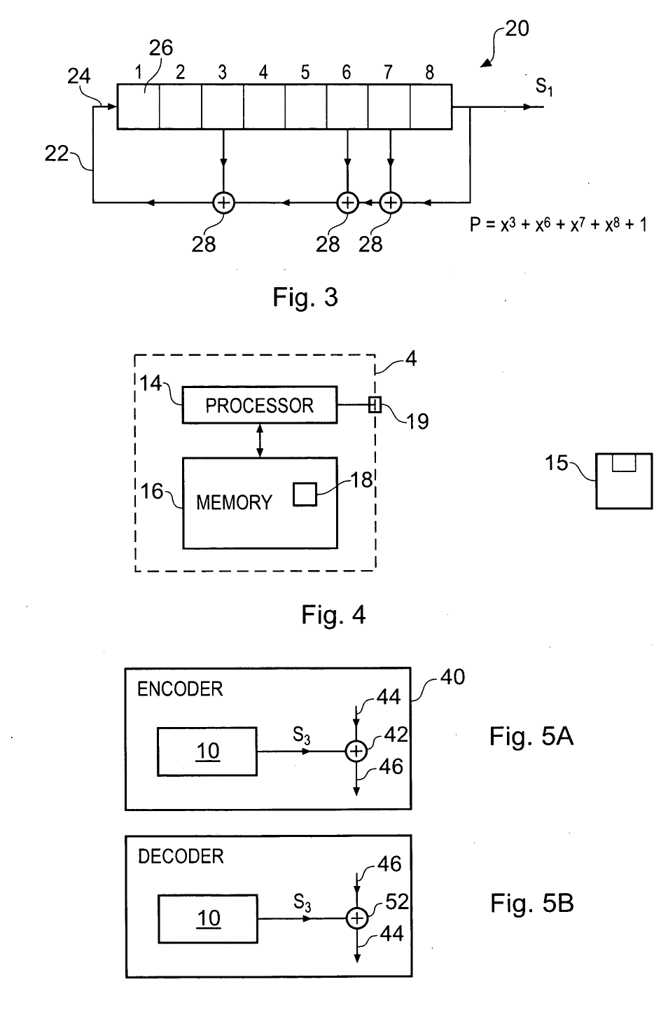

The spreading code generator 2 may be implemented as a linear feedback shift register 20 as illustrated in FIG. 3. A shift register is a group of registers that are connected as a linear series of N registers with output of the register J is provided as the input to the register J+1. The output of the register N is the output of the shift register. With each clock cycle the value in register J is shifted to register J+1. The state of the shift register (i.e. the collection of values of the individual registers) shifts with each clock cycle and the initial register gains a new value.

In a linear feedback shift register, a linear function of the state of the shift register is fed back 22 at each clock cycle as an input 24 to the shift register 20. That is the state of the shift register at a time T becomes input to the shift register (i.e. the value of the initial register 261) at time T+1.

The input value 24 is driven by the exclusive OR (XOR) 28 of selected ones of the values of the registers 26 of the shift register 20. This tap sequence can be represented as a feedback polynomial P.

The spreading code generator 2 may also, in other implementations, be implemented as a modular 2 combination of 2 linear feedback shift registers.

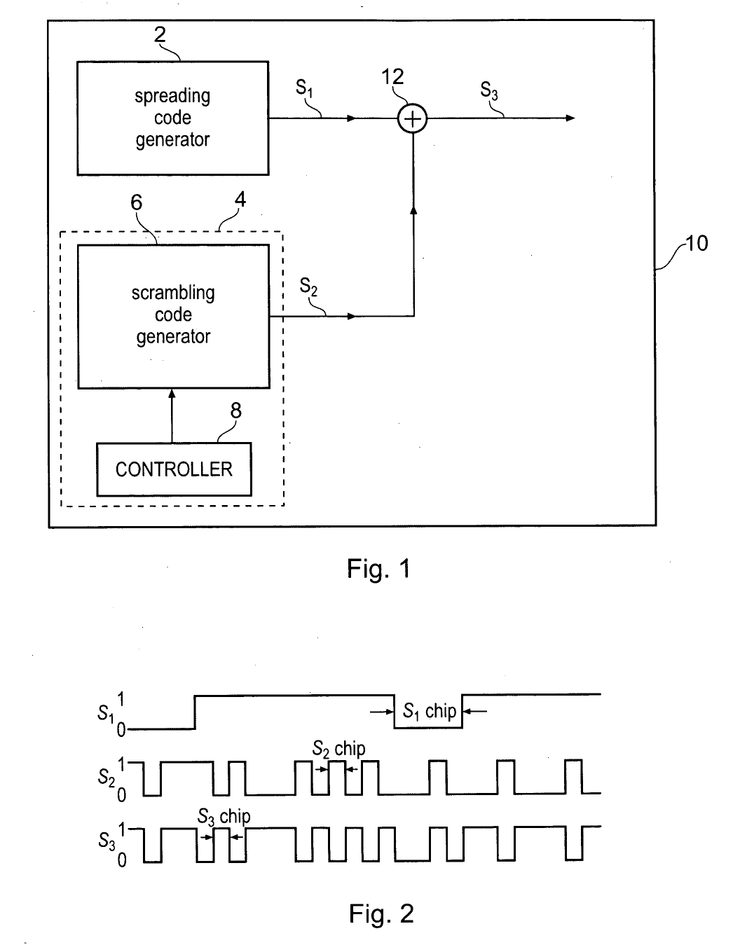

The spreading code S1 generated by the hardware implemented spreading code generator 2 is schematically illustrated in FIG. 2. Spreading code S1 has a code length L1 and a chip rate of M1 chips per second. The software generated scrambling code S2 is also illustrated in FIG. 2. It has a code length L2 and a chip rate M2 chips per second.

In the example illustrated, L2=N*L1 and M2=N*M1. The generated spreading code S1 may be suitable for use in a GPS encoder/decoder in which case L1 is 1023. The scrambled spreading code S3 may be suitable for use in a Galileo encoder/decoder in which case L2 is 4092 and N is 4. It should be appreciated that each chip of the spreading code S1 has been spread to N chips because the scrambling using the scrambling code S2 is sub-chip scrambling i.e. it occurs under the chip level. The spreading code is spread by the spreading code, at the sub-chip level. This increases the bandwidth of the spreading code.

It will be appreciated from FIG. 2, that in this example every chip of the generated spreading code S1 is scrambled (spread or modulated) by N chips of the scrambling code S2. In addition, the whole length of the generated spreading code S1 is scrambled using the whole length of the generated scrambling code S2.

Consequently, the output spreading code S3 has the same length and chip rate as the generated scrambling code S2, in this example, as N is an integer.

However N need not be an integer. It will be appreciated that by carefully selecting the spreading code S1 and the scrambling code S2, the code length of the spread spreading code S3 is the minimum multiple of the code lengths of the spreading code S1 and the scrambling code S2.

The generated scrambling code S2 is a pseudo random code which spreads the generated spreading code S1. The full length L2 of the generated scrambling code S2 may be created by repeating a smaller pseudo random portion.

It will be appreciated from FIG. 2 that the generated spreading code S1, the generated scrambling code S2 and the output spreading code S3 are all binary codes that have values of either 1 or 0.

The scrambling code generator apparatus 10 may be used in a number of applications.

One use of a spreading code is to encode data so that it can be sent via a communications channel and the data can be accurately recovered at a receiver. The use of the spreading code increases the robustness of the communication channel to interference. Such a spread spectrum technique is for example used in code division multiple access radio communications systems such as UMTS, IS-95 or CDMA2000 and also in low power communication systems such as global navigation satellite systems (GNSS) such as the global positioning satellite system (GPS) or the proposed Galileo satellite positioning system. The apparatus 10 may consequently be a module for a cellular mobile telephone or an integral part of a mobile cellular telephone or a module for a GNSS receiver or an integral part of a GNSS receiver.

Another application is security. A spreading code may be used to encode information or data. The spreading obscures the data and knowledge of the spreading code is required to recover the original data. The apparatus 10 may consequently be a module for a security device or an integral part of a security device.

FIG. 5A, schematically illustrates an encoder 40 comprising the apparatus 10 and an XOR gate 42. The spreading code S3 output by the apparatus 20 is exclusively-ORed with data 44 to produce encoded data 46.

FIG. 5B schematically illustrates a decoder 50 comprising the apparatus 20 and an XOR gate 52. The spreading code S3 output by the apparatus 10 is used to de-spread the encoded data 46 to recover the original data 44.

FIG. 6 schematically illustrates a method suitable for use in an apparatus' that is operable in a first GNSS mode and a second GNSS mode. In the example illustrated, the first mode is a GPS mode and the second mode is a Galileo mode.

The Figure illustrates a number of blocks which may be implemented as code portions in a computer program 18 or as steps in a method.

A block 61, a spreading code S1 is generated. Next a block 62 it is tested whether or not the apparatus is in GPS mode or not.

If the apparatus is in a GPS mode, the method moves to block 63 where the generated spreading code S1 is used to decode a received GPS signal. In this example, the length of the spreading code S1 is 1023 chips.

If at block 62 the mode is not found to be GPS, the method moves to block 64 where it is determined whether or not the mode is “Galileo”. If the mode of the apparatus is Galileo, the method moves to block 25 where a scrambling code S2 is generated by a computer 4. The generated scrambling code S2 is then used to scramble the generated spreading code S1 at block 66. Then at block 67, the scrambled spreading code is used to decode a received Galileo satellite signal. The length of the scrambled spreading code S3 is 4092 chips.

According to the method of FIG. 6, the hardware spreading code generator 2 is used in both modes. This results in a simplified dual-mode GNSS receiver,

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a spreading code generator for generating a spreading code having a first chip rate M1;
a scrambling code generator for generating a scrambling code having a second chip rate M2 that is greater than the first chip rate; and
a modulator for scrambling the spreading code using the scrambling code to produce a modified spreading code having a third chip rate that is greater then the first chip rate M1.

2. An apparatus as claimed in claim 1, further comprising a controller for switching the scrambling code generator on or off.

3. An apparatus as claimed in claim 1, wherein the spreading code comprises a plurality of chips and the scrambling code comprises a multiplicity of chips and wherein every chip of the spreading code is scrambled by N chips of the scrambling code.

4. An apparatus as claimed in claim 1, wherein the spreading code has a length L and the scrambling code has a length N*L.

5. An apparatus as claimed in claim 1, wherein the spreading code has a length of 1023 chips.

6. An apparatus as claimed in claim 1, wherein the scrambling code has a length of 4092 chips.

7. An apparatus as claimed in claim 1, wherein the whole of the spreading code is scrambled by the whole of the scrambling code

8. An apparatus as claimed in claim 1, wherein the modulator is an X-OR gate.

9. An apparatus as claimed in claim 1, wherein the spreading code generator is implemented in hardware.

10. An apparatus as claimed in claim 1, wherein the spreading code generator comprises at least one shift register.

11. An apparatus as claimed in claim 1, wherein the scrambling code generator is implemented in software.

12. An apparatus as claimed in claim 1, wherein the scrambling code comprises a pseudorandom portion.

13. An apparatus as claimed in claim 1, wherein the scrambling code comprises a repeated pseudorandom portion.

14. An apparatus as claimed in claim 1, wherein the spreading code, scrambling code and modified spreading code are binary codes.

15. An apparatus as claimed in claim 1, operable as a spread spectrum encoder.

16. An apparatus as claimed in claim 1, operable as a spread spectrum decoder.

17. An apparatus as claimed in claim 1, operable as a GNSS receiver.

18. An apparatus as claimed in claim 17, operable as a receiver for a first satellite positioning system and also as a receiver for a second, different, satellite positioning system.

19. An apparatus as claimed in claim 1, operable as a security device.

20. A method comprising:
generating a spreading code, having a first chip rate M1, using hardware; and
scrambling the spreading code using a scrambling code having a second chip rate M2 that is greater than the first chip rate.

21. A method as claimed in claim 20, wherein the spreading code comprises a plurality of chips and the scrambling code comprises a multiplicity of chips, the method further comprising: scrambling every chip of the spreading code using N chips of the scrambling code.

22. A method as claimed in claim 20, wherein the spreading code has a length L and the scrambling code has a length N*L.

23. A method as claimed in claim 20, wherein the whole of the spreading code is scrambled by the whole of the scrambling code.

24. A method as claimed in claim 20, wherein spreading code has a length of 1023 chips.

25. A method as claimed in claim 20, wherein scrambling code has a length of 4092 chips.

26. A method as claimed in claim 20, further comprising generating the scrambling code using software.

27. A method as claimed in claim 20, wherein the scrambling code comprises a pseudorandom portion.

28. An encoding method comprising:
spreading data using the scrambled spreading code produced by the method of claim 20, to create encoded data.

29. A decoding method comprising
de-spreading encoded data using the scrambled spreading code produced by the method of claim 20, to recover data.

30. A method comprising:
generating spreading codes, having a first chip rate M1, using hardware;
in a first mode, de-spreading data received from a first satellite positioning system using a generated spreading code;
in a second mode, scrambling a generated spreading code using a scrambling code, having a second chip rate M2 that is greater than the first chip rate. and de-spreading data received from a second satellite positioning system using the scrambled spreading code.

31. A computer program comprising computer program instructions for generating a scrambling code for scrambling a generated spreading code to generate a scrambled spreading code.
